(19) United States
(12) Patent Application Publication
(10) Pub. No.: US 2025/0200137 A1
(43) Pub. Date: Jun. 19, 2025

(54) METHOD AND SYSTEM FOR RECONFIGURABLE QUANTIZATION

(71) Applicant: Rain Neuromorphics Inc., San Francisco, CA (US)

(72) Inventors: Marios Fournarakis, London (GB); Mohammed Elneanaei Abdelmoneem Fouda, Irvine, CA (US)

(21) Appl. No.: 18/979,071

(22) Filed: Dec. 12, 2024

Related U.S. Application Data
(60) Provisional application No. 63/610,925, filed on Dec. 15, 2023.

(51) Int. Cl. G06F 17/16; G06F 7/32

(52) U.S. Cl. CPC G06F 17/16; G06F 7/32

(57) ABSTRACT

A compute-in-memory (CIM) system is described. The CIM system includes vector-matrix multiplication (VMM) engines and a combiner circuit. The VMM engines determine a multiplication of a stored element of a tensor and an input vector. The combiner circuit is coupled with the VMM engines. At least one of a portion of the VMM engines or a portion of the combiner circuit are configured to be selectively enabled for a desired precision of multiple possible precisions.

### CROSS REFERENCE TO OTHER APPLICATIONS

This application claims priority to U.S. Provisional Patent Application No. 63/610,925 entitled METHOD AND SYSTEM FOR RECONFIGURABLE QUANTIZATION filed Dec. 15, 2023 which is incorporated herein by reference for all purposes.

### BACKGROUND OF THE INVENTION

Artificial intelligence (AI), or machine learning, utilizes learning networks loosely inspired by the brain in order to solve problems. Learning networks typically include layers of weights that weight signals (mimicking synapses) combined with activation layers that apply functions to the signals (mimicking neurons). The weight layers are typically interleaved with the activation layers. In the forward, or inference, path, an input signal is propagated through the learning network. In so doing, A weight layer can be considered to multiply input signals (the “activation” for that weight layer) by the weights stored therein and provide corresponding output signals. For example, the weights may be analog resistances or stored digital values that are multiplied by the input current, voltage or bit signals. The weight layer provides weighted input signals to the next activation layer, if any. Neurons in the activation layer operate on the weighted input signals by applying some activation function (e.g. ReLU or Softmax) and provide output signals corresponding to the statuses of the neurons. The output signals from the activation layer are provided as input signals (i.e. the activation) to the next weight layer, if any. This process may be repeated for the layers of the network, providing output signals that are the resultant of the inference. Learning networks are thus able to reduce complex problems to a set of weights and the applied activation functions. The structure of the network (e.g. the number of and connectivity between layers, the dimensionality of the layers, the type of activation function applied), including the value of the weights, is known as the model.

Although a learning network is capable of solving challenging problems, the computations involved in using such a network are often time consuming. For example, a learning network may use millions of parameters (e.g. weights), which are multiplied by the activations to utilize the learning network. Learning networks can leverage hardware, such as graphics processing units (GPUs) and/or AI accelerators, which perform operations usable in machine learning in parallel. Such tools can improve the speed and efficiency with which data-heavy and other tasks can be accomplished by the learning network. However, efficiency of such tools may still be less than desired. Challenges such as accuracy, power consumption, and latency remain. Further, the hardware tools may not be sufficiently flexible to adequately address different models that may be used for different tasks or different precisions. Consequently, improvements are desired.

### BRIEF DESCRIPTION OF THE DRAWINGS

Various embodiments of the invention are disclosed in the following detailed description and the accompanying drawings.

FIGS. 1A and 1B are diagrams of an embodiment of a compute-in-memory hardware module of a compute engine usable in an accelerator for a learning network and an environment in which the compute-in-memory hardware module may be used.

FIGS. 2A-2B depict an embodiment of a portion of a compute-in-memory hardware module of a compute engine usable in an accelerator for a learning network.

FIG. 3 depicts an embodiment of a portion of a compute-in-memory hardware module of a compute engine usable in an accelerator for a learning network.

FIG. 4 depicts an embodiment of the data flow in a learning network in which the compute-in-memory hardware module may be used.

FIG. 5 is a flow chart depicting an embodiment of a method for determining portions of the compute-in-memory hardware module to be activated and the desired precisions.

FIG. 6 is a flow chart depicting an embodiment of a method for using a compute engine usable in an accelerator for a learning network.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Artificial intelligence (AI), or machine learning, utilizes learning networks to perform various tasks. Learning networks typically include layers of weights that weight signals (mimicking synapses) combined with activation layers that apply activation functions to the signals (mimicking neurons). The weight layers are typically interleaved with the activation layers. Thus, a layer of the network may be considered to include both a weight layer and a corresponding activation layer. During training, parameters such as the values of the weights and the desired activation functions (e.g. ReLu or Softmax) are determined for the learning network and the particular problem(s) to be solved. The model, which includes structure of the network as well as the parameters determined during training (e.g. the values of the weights), may then be implemented on the learning network to perform the desired tasks.

The operations performed by the learning network may be accomplished more efficiently using hardware such as AI accelerators, which perform operations usable in machine learning in parallel. Such tools can improve the speed and efficiency with which data-heavy and other tasks can be accomplished by the learning network. However, further improvements are desired. For example, power consumption and accuracy are often competing concerns in design and use of such learning networks. The use of higher precision weights and activations (e.g. input vectors, or data) generally lead to more accurate results. For example, learning networks are often trained using weights, activations, and target outputs having FP32 (floating point thirty-two bit representations of the weights and activations) precision. As a result, the output from training is generally very accurate. However, utilizing the hardware implementing the learning network with an FP32 precision consumes a significant amount of power. In general, the power consumed for hardware increases with increasing precision. Thus, to reduce power consumption and improve latency during use, a lower precision may be desired. For example, INT4 or INT 8 (which use four or eight bit integers to represent weights and elements of the activation) may consume significantly less power and have lower latency. However, accuracy may be adversely affected. In addition, a particular precision (and thus a particular power consumption and a particular accuracy) may be sufficient for some tasks but not others. Typically, a change in precision requires swapping the values of the weights stored in hardware. The latency for loading or swapping weights or other values may be significant. This is particularly true for higher precision weights because more bits are required to be swapped for each weight. Such swapping also typically requires that weights for each precision are separately stored, for example in DRAM. This may consume a significant amount of memory. This is particularly problematic in learning networks implemented on edge devices, such as mobile phones. Alternatively, providing the weights to be swapped wirelessly instead of storing such weights may dramatically increase latency. Consequently, improvements in hardware accelerators for learning networks, particularly in power consumption and accuracy, are desired.

A compute-in-memory (CIM) system includes vector-matrix multiplication (VMM) engines and a combiner circuit. The VMM engines determine a multiplication of a stored element of a tensor and an input vector. The combiner circuit is coupled with the VMM engines. At least one of a portion of the VMM engines or a portion of the combiner circuit are configured to be selectively enabled for a desired precision of multiple possible precisions.

In some embodiments, each of the VMM engines is configured in an element-stationary architecture (e.g. analogous to a weight-stationary architecture). Thus, the possible precisions are achievable without changing the stored element. In some such embodiments, each VMM engine also includes storage cell(s) and multiplication circuitry. The storage cell(s) each store a portion of the stored element of the tensor. The multiplication circuitry multiples the portion of the stored element with the input vector. In some embodiments, the stored element is a quantized representation of a higher precision element. In some embodiments, each of the VMM engines is configured to be selectively enabled (e.g. powered on) for the desired precision of the possible precisions. In some embodiments, each of the VMM engines is a bit-wise VMM engine.

The CIM system may also include a controller. The controller is configured to provide control signal(s) to the VMM engines or the combiner circuit to selectively enable the portion of the VMM engines and/or the portion of the combiner circuit. The control signal(s) are based on an optimization between of at least one of precision for the tensor, an energy consumption corresponding to the VMM performed by the CIM system, and/or a latency for storing data in the plurality of VMM engines.

A learning network including multiple layers is described. Each of the layers includes a weight layer and an activation layer. The weight layer includes VMM engines and combiner circuits. The VMM engines are divided into groups of VMM engines. A group of VMM engines determines a multiplication of a stored element of a tensor and an input vector. the activation layer for applies an activation function to an output of the weight layer. At least one of a portion of the group of VMM engines or a portion of the combiner circuit are configured to be selectively enabled for a desired precision of a plurality of possible precisions. The stored element may be selected from a weight and an element of an activation.

The weight layer may also include controllers. A controller is configured to provide at least one control signal to the at least one of the group of VMM engines or the combiner circuit to selectively enable the portion of the group of VMM engines and/or the portion of the combiner circuit. The at least one control signal is based on at least one of an optimization between a precision for the tensor, an energy consumption corresponding to a plurality of VMMs performed by the plurality of VMM engines, or a latency for storing data in the plurality of VMM engines.

A method is described. The method includes selectively enabling at least one of a portion of a plurality of vector-matrix multiplication (VMM) engines or a portion of a combiner circuit. The VMM engines determine a multiplication of a stored element of a tensor and an input vector. The combiner circuit is coupled with the VMM engines. The portion of the VMM engines and/or the portion of the combiner circuit are configured to be selectively enabled for a desired precision of multiple possible precisions of the stored element. An output of the VMM having the desired precision is provided. In some embodiments, Each of the VMM engines is configured in an element-stationary architecture such that the plurality of possible precisions is achievable without changing the stored element. The method may also include determining the portion of the VMM engines and/or the portion of the combiner circuit to be enabled based on an optimization between at least one of a precision for the tensor, an energy consumption corresponding to a plurality of VMMs performed by the plurality of VMM engines, and a latency for storing data in the plurality of VMM engines.

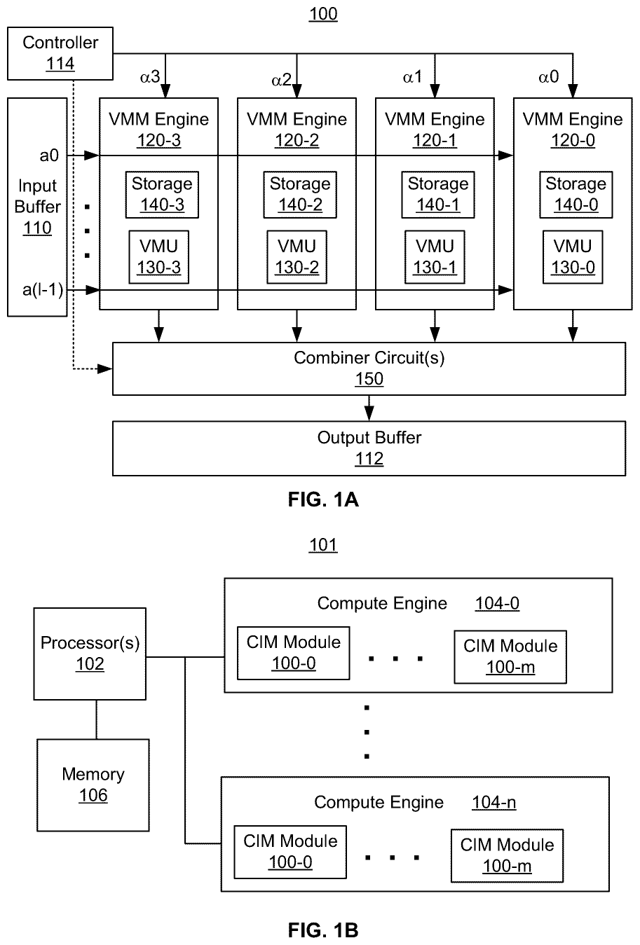

FIGS. 1A and 1B are diagrams of an embodiment of compute-in-memory (CIM) hardware module 100 of a compute engine usable in an accelerator for a learning network and an environment 101 in which CIM hardware module 100 may be used. FIG. 1A depicts CIM hardware module 100. FIG. 1B depicts at least a portion of hardware accelerator 101 with which CIM hardware module 100 may be used. Hardware accelerator 101 may be a tile, portion of a tile, a system on a chip (SoC) or other analogous environment. Thus, hardware accelerator 100 is termed a tile. Tile 101 includes processor(s) 102, compute engines 104-0 through 104-n (collectively or generically compute engine(s) 104), and memory 106. Other components may be present but are not depicted for clarity. Each compute engine 104 may include multiple CIM hardware modules 100-0 through 100-m. CIM hardware module 100-0 through 100-m are analogous to CIM hardware module 100 depicted in FIG. 1A. A compute engine 104 may perform operations for a portion of a tensor (e.g. a weight tensor), a tensor, or multiple tensors. Thus, compute engine 104 may perform calculations for a layer (e.g. a weight layer), a portion of a layer, or multiple layers of a learning network.

CIM hardware module 100 stores elements of a tensor and performs operations in parallel on the elements. For simplicity, CIM hardware module 100 is described in the context of storing weights and performing operations using activations input to CIM hardware module 100. CIM hardware module 100 is thus described as performing vector-matrix multiplications (VMMs), where the vector may be an input activation (e.g. provided using processor 102) and the matrix may be weights (i.e. data/parameters/stored tensor elements) stored by CIM hardware module 100. However, other tensors and/or input vectors may be used. In some embodiments, the vector may be a matrix. In some embodiments, for example, CIM hardware module 100 may store activations and perform operations on the activations.

CIM hardware module 100 includes input buffer 110, output buffer 112, controller 114, multiple VMM engines 120-0 through 120-3 (collectively or generically VMM engine(s) 120), and combiner circuit(s) 150. Input buffer 110 receives the vector to be multiplied by CIM hardware module 100. For example, input buffer 110 may receive the activation to be multiplied by a weight matrix. Output buffer 112 stores results that may be provided to another compute engine 104, another CIM hardware module 100, memory 106, processor(s) 102, and/or another tile that might be analogous to tile 101. Controller 114 provides control signals (e.g. a0, α1, α2, and α3) for selectively enabling VMM engines 120. In some embodiments, controller 114 provides analogous control signal(s) to combiner circuit(s) 150 to selectively enable portions of combiner circuit(s) 150. Controller 114 may also provide control signals to both VMM engines 120 and combiner circuit(s) 150. In some embodiments, input buffer 110, output buffer 112, and/or controller 114 may be considered part of compute engine 104 that is separate from CIM hardware module 100.

VMM engines 120 are configured to perform VMMs of weights of a weight matrix (e.g. stored elements of a tensor) stored by VMM engines 120 and an input vector. Combiner circuit 150 appropriately combines the outputs of VMM engines 120 and provides the combined output to output buffer 112.

In some embodiments, each VMM engine 120 performs bit-wise VMMs on the weight and an input vector (e.g. input vector ap, where i goes from 0 through l−1, where l−1 is the number of elements in the vector). VMM engines 120-0, 120-1, 120-2, and 120-3 thus include storage 140-0, 140-1, 140-2, and 140-3 (collectively or generically 140), respectively, and vector multiplication unit (VMU) 130-0, 130-1, 130-2, and 130-3 (collectively or generically 130), respectively. Storage 140 stores the elements (e.g., bits) of the weight(s). VMUs perform 130 include circuitry that perform the VMM of the bits stored in storage 140 with the input vector (ai) from input buffer 110.

In the embodiment shown, CIM hardware module 100 performs operations for four bits of a weight. VMM engines 120 may store an entire weight for an INT4 precision weight. Thus, four VMM engines 120-0, 120-1, 120-2, and 120-3 are shown. In another embodiment, another number of VMM engines 120 may be present in CIM hardware module 100. For example, if CIM hardware module is desired to perform VMMs for each weight (e.g. each stored element of the tensor) and each weight has a maximum eight-bit precision (e.g. INT8), then eight VMM engines 120 may be present. Alternatively, two CIM hardware modules 100 may be used for INT8. For clarity, CIM hardware module 100 is described in the context of INT4 weights. However, as indicated, a higher precision may be utilized in an analogous manner by adding the appropriate number of VMM engines 120 and extending combiner circuit(s) 150.

In some embodiments, each VMM engine 120 performs operations for one column of weights in the tensor. Thus, VMM engine 120-0 stores and operates on the least significant bit (LSB) for each weight in the column. VMM engine 120-1 stores and operates on the next to LSB for each weight in the column. VMM engine 120-2 stores and operates on the next to most significant bit (MSB) for each weight in the column. VMM engine 120-3 stores and operates on the MSB for each weight in the column. In such embodiments, VMM engines 120-0 through 120-3 are replicated for each column in the weight tensor. In some embodiments, each VMM engine 120 performs operations for a single weight. In such embodiments, VMM engine 120-0 stores and operates on the LSB for the weight. VMM engine 120-1 stores and operates on the next to LSB for the weight. VMM engine 120-2 stores and operates on the next to MSB for the weight. VMM engine 120-3 stores and operates on the MSB for the weight. In such embodiments, VMM engines 120-0 through 120-3 may be replicated for each row and each column in the weight tensor. VMM engines 120 may be configured in another manner, for example to operate on a portion of a column of weights.

CIM hardware module 100 is configured to be used with multiple precisions. In the embodiment shown, CIM hardware module 100 may be used with one bit, two bit, three bit, or four bit precision. To do so, controller 114 selectively enables the appropriate VMM engine(s) 120, portions of combiner circuit(s) 150, or both. For simplicity, CIM hardware module is described in the context of selectively enabling VMM engine(s) 120. As a result, no VMM is performed for a disabled VMM engine 120. Thus, power savings may be greater than if the corresponding portion of combiner circuit(s) 150 are disabled. In the embodiment shown, control signals α0, α1, α2, and α3 are used to enable VMM engines 120-0, 120-1, 120-2, and 120-3 respectively. For example, if four bit precision is used, then control signals α0, α1, α2, and α3 are all enabled. In another example, if three bit precision is used, then some combination of three of α0, α1, α2, and α3 are used. For example, α3, α2, and α1 might be enabled to utilize the three most significant bits stored in VMM engines 120-3, 120-2, and 120-1. In another example, if one bit precision is used, then α0 may be used if the LSB stored in VMM engine 120-0 is desired. Alternatively, α3 might be used to enable VMM engine 120-3 in which the MSB is stored.

CIM hardware module 100 is configured in an element-stationary architecture (e.g. analogous to a weight-stationary architecture). Thus, weights are stored in VMM engines 120 for all precisions that are used (e.g. one bit, two bit, three bit, and four bit precision) for a given set of weights. Stated differently, the multiple possible precisions may be achieved by selectively enabling one or more VMMs 120 using α0, α1, α2, and α3, without swapping the weights. Weights may be swapped for a new model, but need not be swapped for a new precision. As a result, CIM hardware module 100 provides the flexibility of multiple precisions and the power consumption savings that may come with flexible precision without incurring latency penalties due to changing weights stored in VMM engines 120 in order to change precision. Moreover, performance may be optimized by selecting the specific values of α0, α1, α2, and α3 used for each precision and/or by determining the values stored in each VMM engine 120-3 (e.g. that correspond to the quantized representation of the weight stored in each VMM engine).

The precision used may be determined by optimizing performance of the learning network. The specific combination of α0, α1, α2, and α3 for the particular precision, as well as whether a higher precision (e.g. INT8 using multiple CIM hardware modules 100) is used, may be determined by optimizing some combination of the power consumed, latency, and accuracy for each of the precisions that are to be used with CIM hardware module 100. This optimization may be performed for the individual CIM hardware module 100, some or all of the weight tensor of which CIM hardware module 100 may store a portion, a layer in the learning network (e.g. one or more CIM hardware modules 100 corresponding to the weight layer and the application of the corresponding activation function), multiple layers in the learning network, or the entire learning network. Consequently, the CIM hardware module 100 for one layer or one portion of a layer in a learning network may have a different precision and/or different VMM engine(s) 120 activated (i.e. different combinations of α0, α1, α2, and α3) than another CIM hardware module 100.

In general, the power consumed is desired to be reduced, particularly for edge devices (e.g., which may run on battery or otherwise have power consumption constraints). Stated differently, a particular power budget for the learning network is desired to be achieved via the optimization. Latency may be optimized not for storage of weights, other data movement within tile 101, and/or communication between different devices. For example, one layer of a learning network may be implemented on one tile 101, while another layer of the learning network is implemented on another tile 101. Thus, the transfer of activations or other data from one tile to another tile may be part of the optimization. Although high accuracy is generally desired, some accuracy may be sacrificed to meet the power and/or latency constraints for the learning network.

The optimization used in determining α0, α1, α2, and α3 may be understood as follows. Each VMM engine 120 may be a bit-wise engine. Consequently, each VMM engine 120 stores one bit of at least one weight. The weight (up to INT4 in the embodiment shown in FIGS. 1A-1B) is generally a binary representation of a higher accuracy weight (e.g., FP16 or FP32) used in training the learning network. A particular stored (or quantized) weight, w_{q}, may be given by:

$${w}_{q} = {\sum }_{i = 0}^{n - 1} {α}_{i} ( {2}^{i} {b}_{i} ) = {[ \begin{matrix}{α}_{0} & ⋯ & {α}_{n - 1}\end{matrix} ] [ \begin{matrix}{b}_{0} & ⋯ & {2}^{n - 1} {b}_{n - 1}\end{matrix} ]}^{T}$$

In vector formulation the weight w_{q} is:

=α[2⊚b]^{T}

where n is the number of bits, α are the gating valuesϵ{0,1} and bᵢ is the i^{th} bit value. For example, for CIM hardware module 100, the αᵢ is one of α0, α1, α2, and α3, and the bits bᵢ may be: b₀ stored in VMM engine 120-0, b₁ stored in VMM engine 120-1, b₂ stored in VMM engine 120-2, or b₃ stored in VMM engine 120-3.

The weights can be represented as higher dimensional binary tensors. The optimization of the accuracy for weights may be represented by:

$$arg {min}_{b} {\sum }_{j} {λ}_{j} ‖ \frac{w}{{s}_{j}} - {α}_{j} [ 2 ⊙ b ] ‖$$

Where: w is the floating-point weight represented by the binary weight w_{q} stored in CIM hardware module 100, sⱼ is the scaling factor for the j^{th} bit width, λⱼ are weighting factors for the j^{th} bit width (i.e. a weighting applied to a particular configuration), b is the vector or binary values [b₀ . . . bₙ₋₁]ϵ{0,1}ⁿ, 2=[2⁰ . . . 2ⁿ⁻¹] and αᵢ are the target gating combination such as α₃=[1 1 1 0] for the three MSBs being activated. Thus, for each weight, one bit may be gated by the αⱼ.

A mixed precision optimization finds an optimal bit width allocation across the network that maximizes accuracy (or other metric) under one or more resource constraints. For example, the optimization may be represented as:

minimize [symbol] (Q(W,B))

subject to constraint \hat{π}(B) [symbol] 0

where [symbol] (Q(W, B)) is the quantized task loss of the network parameterized by weight W, and bitwidths B=[Bₗ] for l=1, . . . L, where L is the number of layers or other granularity, e.g., channels or blocks.

The resource constraint could be anything but for the purposes of explanation, a memory constraint is used. Thus the constraint becomes

$$\hat{π} ( B ) = {\sum }_{l} {W}_{l} * {B}_{l} - M$$

$$and$$

$${B}_{l} \geq {B}_{min}$$

If the constraint is convex, then optimization problem can be solved very quickly. The bit width of each layer corresponds to a gating value α_{B}_{ₗ}. The accuracy and resource constraints correspond to a nested optimization problem. The outer optimization may be considered to find, based on particular memory constraints (Mⱼ, where j=1, 2, . . . , K for K memory constraints), the optimal bit width allocation, Bᵢ, for each layer (each CIM module 100 of the layer), each portion of each layer, all the layers of the learning network or other block of interest). The inner optimization finds the unique gating functions (i.e. the αᵢ, or combination of α0, α1, α2, and α3 for each CIM hardware module 100) for the memory constraint. In other words, the unique gates per layer under K bitwidth allocations: α^{L}={a_{B}_{ⱼ}} for j=1, . . . K. Further, the accuracy is also optimized using the optimization described above for each of the selected gating functions. Stated differently,

$$arg {min}_{b} \sum {λ}_{j} ‖ \frac{w}{{s}_{j}} - {α}_{j} [ 2 ⊙ b ] ‖$$

is also determined. Although a specific optimization scheme is described above, other optimizations may be used.

In general, the quantized weight w_{q} (e.g., four bits for CIM hardware module 100) may be desired to provide the overall best performance under multiple scenarios (e.g. for multiple precisions). Thus, the learning network utilizing CIM hardware module 100 may be optimized to find bᵢ values that achieve best performance under multiple gating scenarios (multiple precisions). Stated differently, the bits to be used for each precision and the corresponding α0, α1, α2, and α3 may be determined to have the overall best (or desired) performance for a stationary weight. A particular precision (e.g. one bit precision) need not have the best performance if the learning network's performance for other, e.g., higher precision, suffers greatly. Instead, the optimization may be considered to sum over all the possible configurations to provide an average error, which is optimized. The control signal(s) provided by control 114 may thus be based on an optimization between of at least one of precision for the tensor, an energy consumption corresponding to the VMM performed by CIM hardware module 100, a latency for storing data in the plurality of VMM engines 120 and/or moving data between tiles 101, memory constraints, and/or other desired behavior of the learning network utilizing CIM hardware module 100 and/or tile 101.

Thus, CIM hardware module 100 is sufficiently flexible to allow a desired precision to be selected from multiple precisions. Because the control signals, αⱼ, and values of bits stored in each VMM engine 120 are selected such that performance of the learning network may be optimized through selection of a precision without requiring that the weight(s) stored are swapped out. Thus, CIM hardware module may not only have a flexible precision, but also manage limited resources and optimize latency. Thus, performance of a learning network using CIM hardware module 100 may be improved.

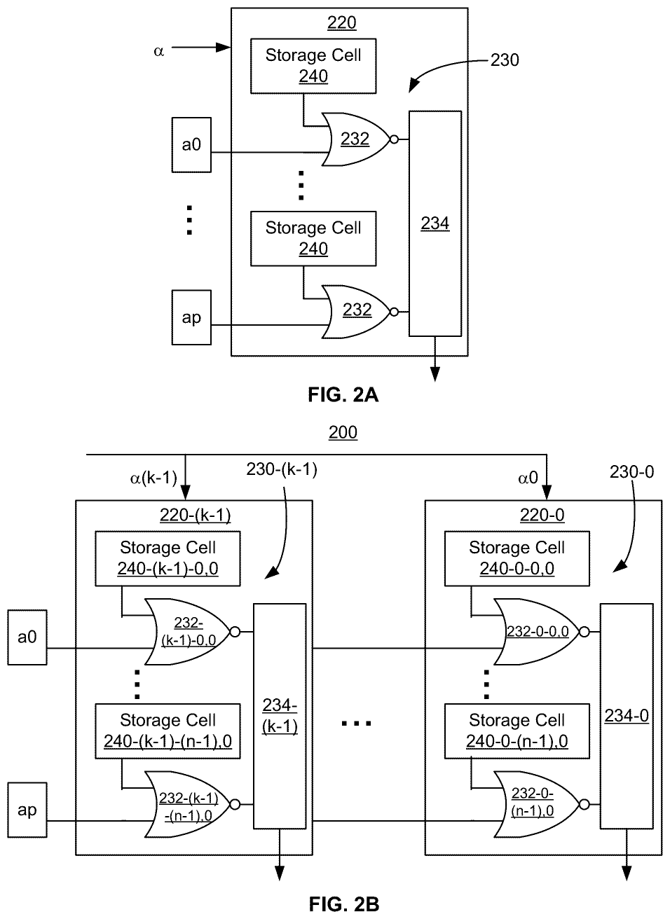

FIGS. 2A-2B depict an embodiment of a portion of a compute-in-memory hardware module of a compute engine usable in an accelerator for a learning network. FIG. 2A depicts an embodiment of a VMM engine 220 analogous to VMM engines 120. FIG. 2B depicts a portion of a CIM hardware module 200 including VMM engines 220-0 through 220-(k−1) (collectively or generically VMM engines 220-i) that has up to a k bit precision. For simplicity, only VMM engines 220-0 and 220-(k−1) for CIM hardware module 200 are shown. However, a controller, combiner circuit(s), input buffer(s), and/or output buffer(s) analogous to controller 114, combiner circuit(s) 150, input buffer 110, and output buffer 112 may be present.

Referring to FIG. 2A, VMM engine 220 may be considered a generic version of a VMM engine that is used to perform a VMM of one bit of one column (or a portion of a column) of weights. VMM engine 220 includes storage cells 240 and VMU 230. Each storage cell 240 stores one bit. VMU 230 includes NOR gates 232 and a compressor and accumulator 234.

VMM engine 220 is selectively activated by control signal, α. VMM engine 220 receives inputs serialized bits of elements a0 through ap of the input activation. Thus, VMM engine 220 may receive sequential inputs of the activation from an input buffer (not shown in FIGS. 2A-2B). NOR gates 232 operate as multipliers of the bit stored in each storage cell 240 with a bit of the input activation. Compressor and accumulator 244 performs an N:1 compression on the output of NOR gates 232, where N is the number of NOR gates 232. Compressor and accumulator 244 also accumulates the compressed product of the inputs and the stored bits. In some embodiments, signed inputs may be used. In such embodiments, compressor and accumulator 244 takes into account the sign of the inputs. In some embodiments, signed weights may also be used. In such embodiments, the sign of the weights may be accounted for in the combiner circuit(s) (not shown in FIGS. 2A-2B). Thus, VMM engine may perform bit wise multiplication of the input with a bit a number of weights.

Referring to FIG. 2B, CIM hardware module 200 includes VMM engines 220-0 through 220-(k−1). Thus, CIM hardware module may have a precision up to k bits. Each VMM engine 220-i includes storage cells 240-i-u,v, where i is the bit number (0 through k−1), and u,v indicate the weight element in the weight tensor stored. For example, storage cell 240-0-0,0 stores bit 0 of weight element woo (column 0, row 0). Similarly, storage cell 240-(k−1)-0,0 stores bit k−1 (i.e. the kl bit) of weight element woo. Storage cell 240-0-(n−1), 0 stores bit 0 of weight element w₍ₙ₋₁₎₀. Storage cell 240-(k−1)-(n−1), 0 stores bit k−1 of weight element w₍ₙ₋₁₎₀.

Each VMM engine 220-i also includes VMU 230-i, where i is the bit number (0 through k−1). VMU 230-i includes NOR gates 232-i-u,v and compressor and accumulator 234-i, where i is the bit number (0 through k−1), and u,v indicate the weight element in the weight tensor stored. For example, NOR gate 232-0-0,0 multiplies bit 0 of weight element woo (i.e. the contents of storage cell 240-0-0,0) with the corresponding bit of element a0 of the input vector. Storage cells 240-i-u,v, VMU 230-i, NOR gates 232-i-u,v, and compressor and accumulators 234-i function in an analogous manner to storage cells 240, VMU 230, NOR gates 232 and compressor and accumulator 234. Thus, CIM hardware module 200 includes sufficient VMM engines 220-i to perform a VMM of each bit (0 through k−1) of k-bit width weights woo through w₍ₙ₋₁₎₀.

In operation, VMM engine 220-i is selectively activated by control signal, α0 through α(k−1). In particular, the VMM engine 220-i powered on only if indicated by the corresponding control signal αi. Each bit of an element of the activation is provided in series to the appropriate VMM engine 220-i. For example, each bit of a0 is provided to a corresponding VMM engine 220-0 through 220-(k−1). NOR gates 232-i-u,v multiply the bit stored in each storage cell 240-i-u,v with a corresponding bit of the input activation (a0 through ap). Compressor and accumulator 244 performs an n:1 compression, where n is the number of NOR gates 232-i-u,v (e.g. NOR gates 232-0-0 through 232-0-(n−1), 0 for VMM engine 220-0). Compressor and accumulator 244-i also accumulates the compressed products of the stored bits and the serialized inputs. In some embodiments, signed inputs may be used. In such embodiments, each compressor and accumulator 244-i takes into account the sign of the inputs. In some embodiments, signed weights may also be used. In such embodiments, the sign of the weights may be accounted for in the combiner circuit(s) (not shown in FIGS. 2A-2B). Thus, VMM engine may perform bit wise multiplication of the input

CIM hardware module 200 and VMM engines 220/220-i share the benefits of CIM hardware module 100 and VMM engines 120. Using control signals α0 through α(k−1), CIM hardware module 200 allows a desired precision to be selected from multiple precisions without weight swapping (i.e. without switching the values of the bits stored in storage cells 240). For example, for 1 bit precision, any of the bits 0 through k−1 may be selected. Because the control signals, α0 through α(k−1), and thus the VMM engines 220-i activated, are selected such that performance of the learning network may be optimized, the precision may be changed and performance optimized without requiring that the weight(s) stored are swapped out. Thus, CIM hardware module 200 may not only have a flexible precision and optimized accuracy, but also manage limited resources and optimize latency. Thus, performance of a learning network using CIM hardware module 200 may be improved.

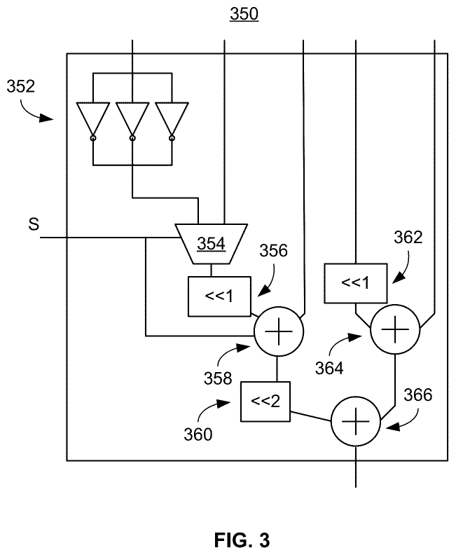

FIG. 3 depicts an embodiment of a portion of a compute-in-memory hardware module of a compute engine usable in an accelerator for a learning network. More specifically, FIG. 3 depicts a portion of combiner circuit 250. Combiner circuit 350 may be replicated in order to be used with multiple CIM hardware modules. Thus, combiner circuit 250 includes inverters 352, multiplexer 354, adders 358, 364, and 368 and shifters 356, 360, and 362. Combiner circuit 350 may be used to account for signed weights. For example, if sign signal, S is set to 1, then combiner circuit 350 applies 2's complement to the sign bit accumulation by inverting all bits and adding one. In the embodiment shown, combiner circuit 350 may be used for four VMM engines 220. Combiner circuit 350 combines the outputs of each VMM engine 220/220-i using the adders 358, 364, and 366 forming a tree with left shifters 356, 360, and (left shift two) 362, to handle the binary weights of the summation.

Thus, a CIM hardware module utilizing VMM engines such as VMM engines 120, 220, and 220-i in combination with combiner circuit(s) 350 may share the benefits of CIM hardware modules 100 and 200 and VMM engines 120, 220, and 220-i. More specifically, performance of the learning network may be optimized and the precision may be changed without requiring that the weight(s) stored are swapped out. Thus, performance of a learning network using a CIM hardware module and combiner circuit 350 may be improved. In other embodiments, a computing unit (e.g., a RISC-V, processor 102, or analogous processor) may be used in lieu of combiner circuit 350. This may provide increased flexibility and controllability in combining of outputs of VMM engines. Such an embodiment may adversely affect performance. For example, data provided to combiner circuit 350 would instead be moved to the computing unit. Consequently, more data may be moved than if the output of combiner circuit 350 is moved (e.g. for application of an activation function). Thus, latency may be increased.

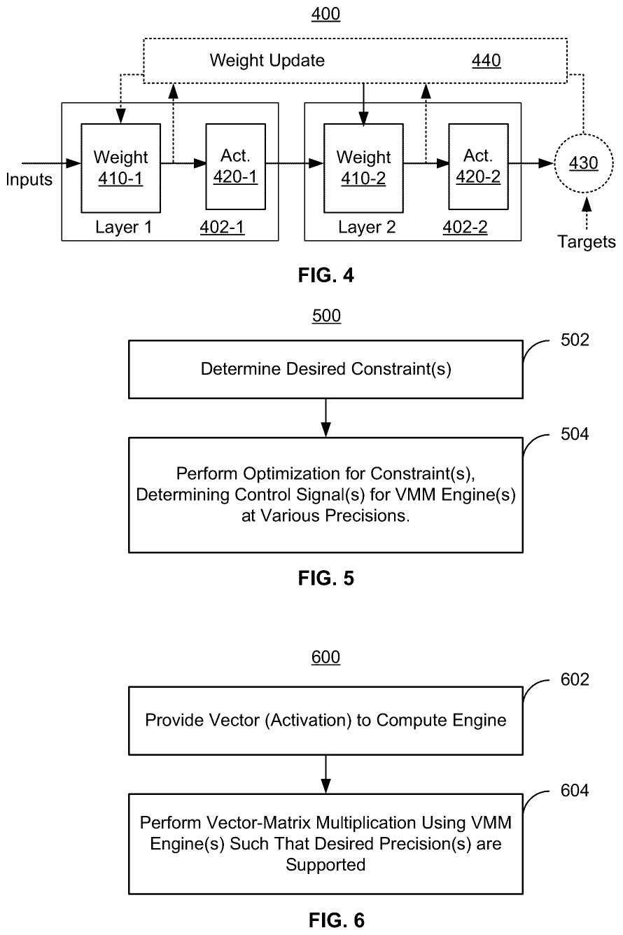

FIG. 4 depicts an embodiment of the data flow 400 in a learning network in which CIM hardware module(s) 100 and/or 200, VMM engines 120, 220, and/or 220-i and combiner circuits 150 and/or 350 may be used. Learning network 400 includes layers 402-1 and 402-2 (collectively or generically 402). For simplicity, only two layers 402 are shown. Typically, a larger number of layers are used. Weight layers 410-1 and 410-2 (collectively or generically 410) and activation layers 420-1 and 420-2 (collectively or generically 420) are in layers 402-1 and 402-2. For training, loss function calculator 430 as well as weight update block 440 are shown. Weight update block 440 might utilize techniques including but not limited to back propagation, equilibrium propagation, feedback alignment and/or some other technique (or combination thereof). In operation, an input vector is provided to weight layer 410-1. A first weighted output is provided from weight layer 410-1 to activation layer 420-1. Activation layer 420-1 applies a first activation function to the first weighted output and provides a first activated output to weight layer 420-2. A second weighted output is provided from weight layer 410-2 to activation layer 420-2. Activation layer 420-2 applies a second activation function to the second weighted output. The output of is provided to loss calculator 430. Using weight update technique(s) 440, the weights in weight layer(s) 410 are updated. This continues until the desired accuracy is achieved. Thus, the desired values of the weights in weight layers 410-1 and 410-2 are determined.

Once trained, the values of weights from weight layers 410, as well as other features of learning network 400, may be imported to analogous learning network. If such a learning network does not undergo training, weight update block 440, targets, and loss calculator 430 are omitted. CIM hardware module(s) 100 and/or 200, VMM engines 120, 220, and/or 220-i and combiner circuits 150 and/or 350 may be used to provide weight layers 410-1 and 410-2 of such a learning network. Activation layers 420 may be implemented using processor 102 or another component. Thus, learning network 400 may enjoy the benefits provided by CIM hardware module(s) 100 and/or 200, VMM engines 120, 220, and/or 220-i and combiner circuits 150 and/or 350. In particular, learning network 400 may have flexible precision at the level of layers 402, network 400, or portions of weight layers 410 while utilizing a weight stationary architecture. Further, the bits within a weight to be activated for a particular precision may be optimized (i.e. the optimized αᵢ control signals determined for each precision). This optimization may, for example, include power consumption, latency, memory availability and type, and/or accuracy. Thus, flexibility may be achieved while optimizing performance.

FIG. 5 is a flow chart depicting an embodiment of method 500 for determining portions of the compute-in-memory hardware module to be activated and the desired precisions. Method 500 is described in the context of CIM hardware modules 100 and/or 200. However, method 500 is usable with other CIM hardware modules. Although particular processes are shown in an order, the processes may be performed in another order, including in parallel. Further, processes may have substeps.

The desired constraints for the learning network are determined, at 502. For example, the power budget for various cases, available memory, available bandwidth for communication, latency, and/or other constraints may be determined. These constraints may be based not only on the hardware and/or software employed, but also the tasks for which the learning network is to be utilized. Similarly, the desired accuracy and precisions may be determined.

An optimization is performed using the constraints and for the VMM engines to be used, at 504. Thus, the control signals to be utilized for each VMM engine and each precision may be determined at 504. In some embodiments, the optimization described herein may be used.

For example, the memory 106, number of tiles 101 used, the power budget, latency for data movement between compute engines 104 and memory 106 (or off tile, e.g., to or from DRAM) may be determined, at 502. At 504, the control signals from controller to VMM engines 120, 220, and/or 220-i may be determined by optimizing the performance of learning network 400. As mentioned, the optimization may provide an average optimization of the performance such that a weight stationary architecture may be used without significantly adversely affecting performance. Consequently, the appropriate control signals for VMM engines 120, 220, and/or 220-i may be determined such that not only may the desired precision be achieved, but performance of the learning network 400 using VMM engines 120, 220, and/or 220-i may be improved.

FIG. 6 is a flow chart depicting an embodiment of a method for using a compute engine usable in an accelerator for a learning network. Method 600 is described in the context of CIM hardware modules 100 and/or 200. However, method 600 is usable with other CIM hardware modules. Although particular processes are shown in an order, the processes may be performed in another order, including in parallel. Further, processes may have substeps.

The input vector is provided to one or more compute engines, at 602. For example, the elements of the input vector, such as an activation, may be provided to the input buffer of a CIM hardware module.

The VMM is performed at the desired precision, at 604. Thus, the appropriate control signals may be provided to the VMM engines, the combiner circuit(s), or both. Consequently, VMM engines are selectively enabled. Also at 604, the output of the VMM engines may be combined using combiner circuit(s) or other techniques. Thus, a VMM having the desired precision and using the optimized bits of each weight is performed at 604.

For example, an input vector may be provided to input buffer 110, at 602. At 604, the appropriate control signals (e.g. αᵢ) are provided to each VMM engine 120, 220, or 220-i. In other embodiments, control signal(s) may be provided to combiner circuit(s) 150 and 350 or both each VMM engine 120, 220, or 220-i and combiner circuit(s) 150 and 350. Thus, one or more bits of each weight for the precision are selectively activated for a VMM. Further, these bits may be optimized to provide the desired performance for the precision. At 604, VMM engines 120, 220, and/or 220-i that have been activated perform the VMM between the corresponding bits and the input vector. The output may be provided to combiner circuit(s) 150 and/or 350 also as part of 604.

Using method 600, the desired precision may be achieved while optimizing performance of the CIM hardware module. Consequently, performance of the learning network using method 600 may be achieved.

Although the foregoing embodiments have been described in some detail for purposes of clarity of understanding, the invention is not limited to the details provided. There are many alternative ways of implementing the invention. The disclosed embodiments are illustrative and not restrictive.

1. A compute-in-memory (CIM) system, comprising:
a plurality of vector-matrix multiplication (VMM) engines for determining a multiplication of a stored element of a tensor and an input vector; and
a combiner circuit, coupled with the plurality of VMM engines;
wherein at least one of a portion of the plurality of VMM engines or a portion of the combiner circuit are configured to be selectively enabled for a desired precision of a plurality of possible precisions.

2. The CIM system of claim 1, wherein each of the plurality of VMM engines is configured in an element-stationary architecture such that the plurality of possible precisions is achievable without changing the stored element.

3. The CIM system of claim 2, wherein each of the plurality of VMM engines includes:
at least one storage cell for storing a portion of the stored element of the tensor; and
multiplication circuitry for multiplying the portion of the stored element with the input vector.

4. The CIM system of claim 1, wherein each of the plurality of VMM engines is configured to be selectively enabled for the desired precision of the plurality of possible precisions.

5. The CIM system of claim 1, wherein each of the plurality of VMM engines is a bit-wise VMM engine.

6. The CIM system of claim 1, further comprising:
a controller configured to provide at least one control signal to the at least one of the plurality of VMM engines or the combiner circuit to selectively enable the at least one of the portion of the plurality of VMM engines or the portion of the combiner circuit, the at least one control signal being based on an optimization between a precision for the tensor and an energy consumption corresponding to the VMM performed by the CIM system.

7. The CIM system of claim 6, wherein the controller is further configured to provide the at least one control signal based on the optimization between the precision for the tensor, the energy consumption corresponding to the VMM performed by the CIM system, and a latency for storing data in the plurality of VMM engines.

8. The CIM system of claim 1, wherein the stored element is a quantized representation of a higher precision element.

9. The CIM system of claim 1, wherein the stored element is selected from a weight and an element of an activation.

10. A learning network, comprising:
a plurality of layers, each of the plurality of layers including:
a weight layer including a plurality of vector-matrix multiplication (VMM) engines and a plurality of combiner circuits, the plurality of VMM engines being divided into a plurality of groups of VMM engines, a group of VMM engines of the plurality of groups of VMM engines for determining a multiplication of a stored element of a tensor and an input vector; and
an activation layer for applying an activation function to an output of the weight layer;
wherein at least one of a portion of the group of VMM engines or a portion of the combiner circuit are configured to be selectively enabled for a desired precision of a plurality of possible precisions.

11. The learning network of claim 10, wherein the at least one of the portion of the group of VMM engines or the portion of the combiner circuit are selectively enabled such that a first layer of the plurality of layers has a different precision than a second layer of the plurality of layers.

12. The learning network of claim 10, wherein the at least one of the portion of the group of VMM engines or the portion of the combiner circuit are selectively enabled such that such that a first portion of a layer of the plurality of layers has a different precision than a second portion of the layer.

13. The learning network of claim 10, wherein each VMM engine of the group of VMM engines is configured in an element-stationary architecture such that the plurality of possible precisions is achievable without changing the stored element.

14. The learning network of claim 13, wherein each of the plurality of VMM engines includes:
at least one storage cell for storing a portion of the stored element of the tensor; and
multiplication circuitry for multiplying the portion of the stored element with the input vector.

15. The learning network of claim 10, wherein each of the plurality of VMM engines is a bit-wise VMM engine.

16. The learning network of claim 10, wherein the weight layer further includes:
a plurality of controllers, a controller of the plurality of controllers being configured to provide at least one control signal to the at least one of the group of VMM engines or the combiner circuit to selectively enable the at least one of the portion of the group of VMM engines or the portion of the combiner circuit, the at least one control signal being based on at least one of an optimization between a precision for the tensor, an energy consumption corresponding to a plurality of VMMs performed by the plurality of VMM engines, or a latency for storing data in the plurality of VMM engines.

17. The learning network of claim 10, wherein the stored element is selected from a weight and an element of an activation.

18. A method, comprising:
selectively enabling at least one of a portion of a plurality of vector-matrix multiplication (VMM) engines or a portion of a combiner circuit, the plurality of VMM engines for determining a multiplication of a stored element of a tensor and an input vector, the combiner circuit being coupled with the plurality of VMM engines, the at least one of the portion of the plurality of VMM engines or the portion of the combiner circuit are configured to be selectively enabled for a desired precision of a plurality of possible precisions of the stored element; and
providing an output of the VMM having the desired precision.

19. The method of claim 18, wherein each of the plurality of VMM engines is configured in an element-stationary architecture such that the plurality of possible precisions is achievable without changing the stored element.

20. The method of claim 18, further comprising:
determining the at least one of the portion of the plurality of VMM engines or the portion of the combiner circuit to be enabled based on an optimization between at least one of a precision for the tensor, an energy consumption corresponding to a plurality of VMMs performed by the plurality of VMM engines, and a latency for storing data in the plurality of VMM engines.
